(19) United States
(12) Patent Application Publication
(10) Pub. No.: US 2011/0240423 A1
(43) Pub. Date: Oct. 6, 2011

(54) BRAKE BLOCK FOR BICYCLE

(75) Inventor: Wayne-Ian Moore, Changhua County (TW)

(73) Assignee: ASHIMA LTD., Changhua County (TW)

(21) Appl. No.: 12/753,115

(22) Filed: Apr. 2, 2010

(51) Int. Cl. F16D 69/02; F16D 65/04; B62L 1/10; F16D 65/092

(52) U.S. Cl. 188/251 A

(57) ABSTRACT

A brake block for bicycle includes a base which is made by plastic injection molding and a pad body made of rubber. The base has a fixing portion formed on one side thereof and a connecting portion formed on an opposite side thereof. The connecting portion is connected with the fixing portion. The pad body has one side integrally covers the connecting portion, such that the base and the pad body formed an integral part. The pad body has a braking portion formed on an opposite side thereof for providing frictional effect.

### BACKGROUND OF THE INVENTION

1. Field of the Invention

The present invention relates to a brake block for bicycle, and more particularly, to a brake block which has a fixing portion made of plastic and a pad body made of rubber.

2. Description of Related Art

Cycling has become an extremely popular recreational activity throughout the world in recent decades. As more and more people indulge themselves in cycling, a demand for innovation and improvement of bicycles and bicycle parts has arisen.

A conventional brake block for bicycle is shown in FIG. 9. The conventional brake block is integrally and entirely made of rubber by press molding. The conventional brake block includes a braking surface 41 and an engaging part 42. A groove 43 is formed in an outer periphery of the engaging part 42 for engaging with a holder 5 of a bicycle brake shoe, such that a flange 51 on the holder 5 is engaged with the groove 43 for fixing the brake block 4 on the holder 5. Therefore, the braking surface 41 frictionally contacts with a wheel rim of a bicycle for providing a frictional effect.

However, the conventional brake block has the following drawbacks: first of all, the conventional brake block is integrally made of rubber by press molding. A tolerance range in size of the conventional brake block made by press molding is generally between +/−0.3. This huge tolerance range in size makes it difficult for the brake block to fittedly assemble with the holder 5, such that the brake block may easily detach from the holder 5. Furthermore, due to a deformable texture of rubber, the brake block is easily deformed when it is frictionally contacted with the wheel rim when operating, such that a frictional effect of the braking surface 41 is reduced. In addition, when the brake block is gradually and entirely worn, the holder 5 is exposed, and directly contacts with the wheel rim, thereby the holder is easily damaged.

The present invention has arisen to obviate/mitigate the disadvantages of the conventional brake block for bicycle.

### SUMMARY OF THE INVENTION

The main objective of the present invention is to provide an improved brake block for bicycle.

To achieve the objective, the brake block for bicycle in accordance with the present invention comprises a base which is made by plastic injection molding and a pad body made of rubber. The base has a fixing portion formed on one side thereof and a connecting portion formed on an opposite side thereof. The fixing portion has a slot circumferentially defined in an outer periphery thereof for slidably engaging with a holder of a bicycle brake shoe. The connecting portion includes at least one neck connecting with the fixing portion and a connecting plate which is mounted on the at least one neck. In one aspect of the present invention, the connecting portion includes a plurality of necks connecting with the fixing portion. A gap is defined in every two adjacent necks. The connecting plate has a high coefficient of friction, such that a friction sound bursts when the connecting plate is frictionally contacted. The pad body has one side integrally covering the connecting plate and is partially fillingly received in the gaps defined in every two adjacent necks of the connecting portion of the base; such that the base and the pad body formed an integral part. An opposite side of the pad body has a braking portion formed thereon for providing a frictional effect. The base and the pad body have different colors. The color of the base is contrasting with that of the pad body for indicating wear of the pad body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of a brake block for bicycle in accordance with the present invention;

FIG. 2 is top plane view of the brake block for bicycle in accordance with the present invention;

FIG. 3 is a cross-sectional view taken along segment A-B of FIG. 2;

FIG. 4 is an assembled perspective view of the brake block for bicycle in accordance with the present invention;

FIG. 5 is another assembled perspective view of the brake block for bicycle in accordance with the present invention viewing from a different angle;

FIG. 6 is an exploded perspective view of a holder for bicycle brake shoe and the brake block for bicycle in accordance with the present invention;

FIG. 7 is a perspective view of the brake block for bicycle assembled to the holder for bicycle brake shoe in accordance with the present invention;

FIG. 8 is cross-sectional view taken along segment C-D of FIG. 7; and

FIG. 9 is an exploded perspective view of a brake block and a holder for bicycle brake shoe in accordance with prior art.

### DETAILED DESCRIPTION OF THE INVENTION

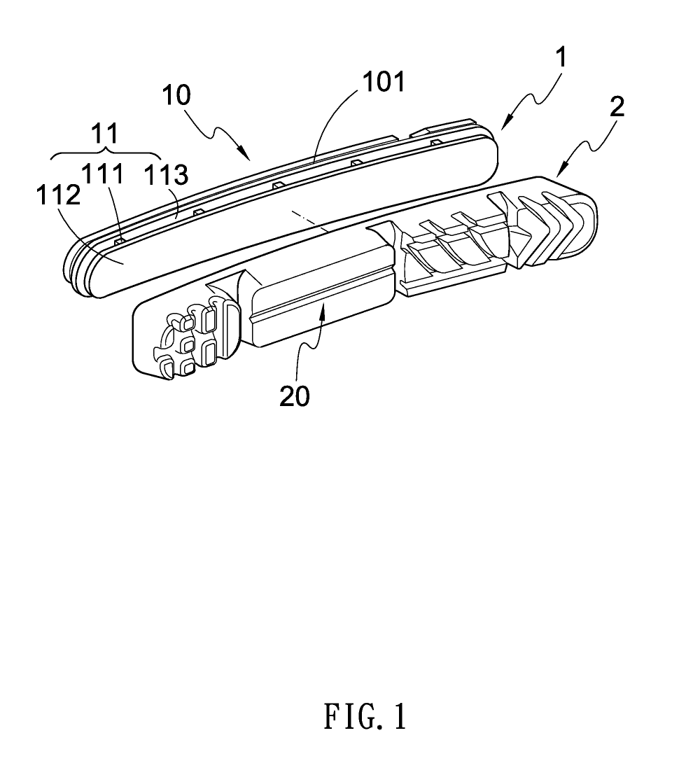

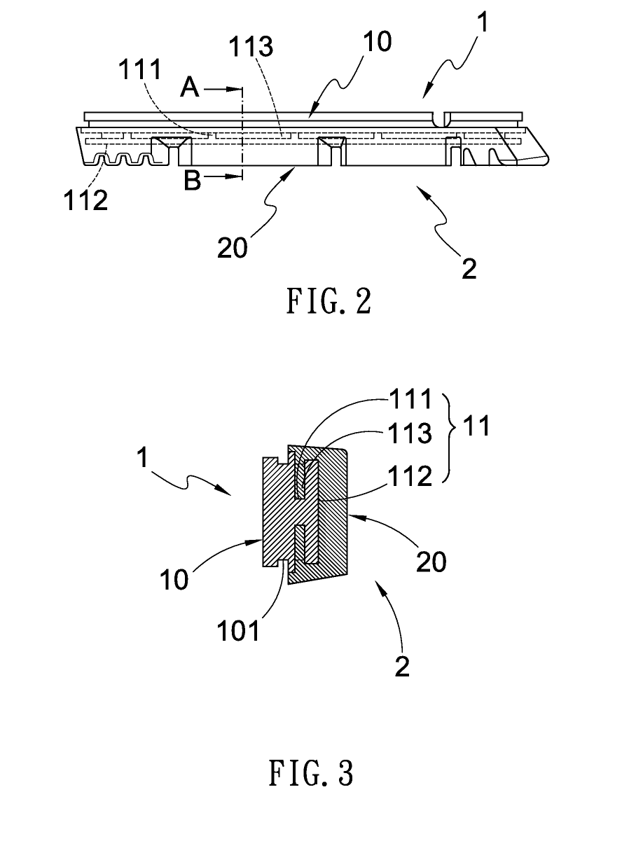

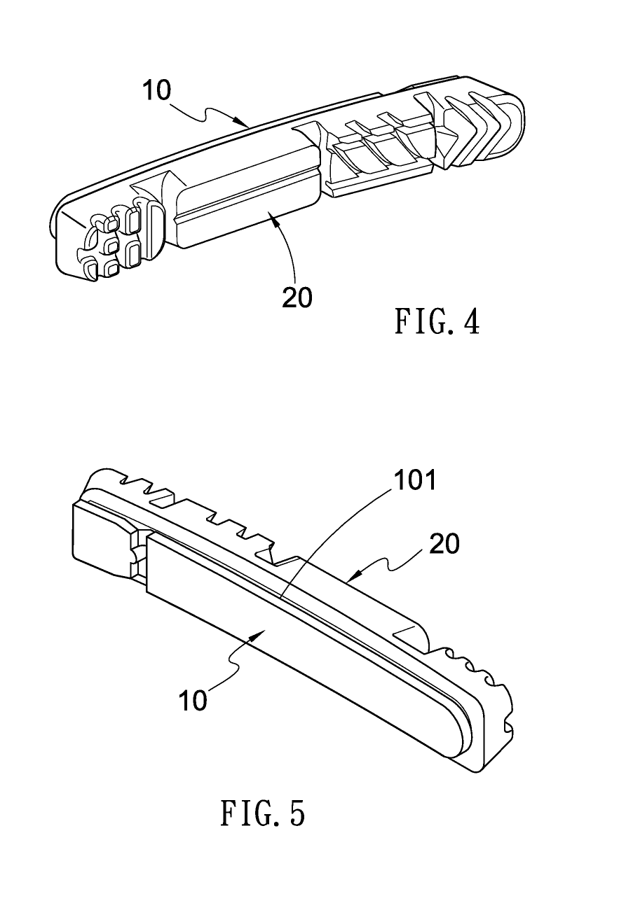

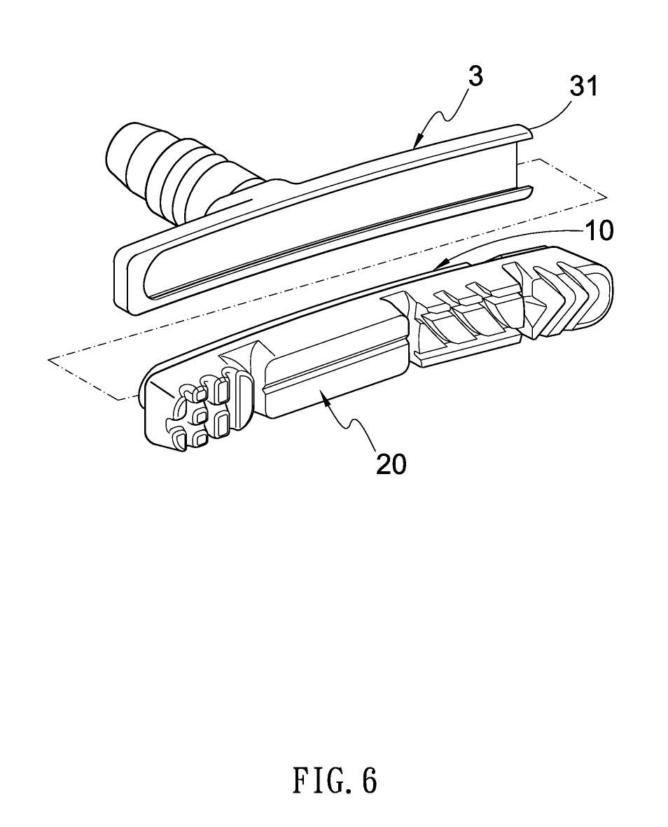

Referring to the drawings and initially to FIGS. 1-5, a brake block for bicycle in accordance with the present invention comprises a base 1 which is made by plastic injection molding and a pad body 2 made of rubber. Both the base 1 and the pad body 2 are elongated shaped. The base 1 has a fixing portion 10 formed on one side thereof and a connecting portion 11 formed on an opposite side thereof. The fixing portion 10 has a slot 101 circumferentially defined in an outer periphery thereof for slidably engaging with a holder 3 of a bicycle brake shoe. The connecting portion 11 includes at least one neck 111 connecting with the fixing portion 10 and a connecting plate 112 which is mounted on the at least one neck 111. In the present embodiment, the connecting portion 11 includes a plurality of necks 111 connecting with the fixing portion 10. A gap 113 is defined in every two adjacent necks 111. The connecting plate 112 has a high coefficient of friction, such that a friction sound bursts when the connecting plate 112 is frictionally contacted. As shown in FIG. 3, the pad body 2 has one side integrally covering the connecting plate 112 and is partially fillingly received in the gaps 113 defined in every two adjacent necks 111 of the connecting portion 11 of the base 1; such that the necks 111 and the connecting plate 112 are thoroughly covered by the pad body 2, therefore the base 1 and the pad body 2 formed an integral part, such that the base 1 and pad body 2 are structurally enhanced. An opposite side of the pad body 2 has a braking portion 20 formed thereon for providing a frictional effect to a wheel rim of a bicycle (not shown). The base 1 and the pad body 2 have different colors. The color of the base 1 is contrasting with that of the pad body 2 for indicating wear of the pad body 2.

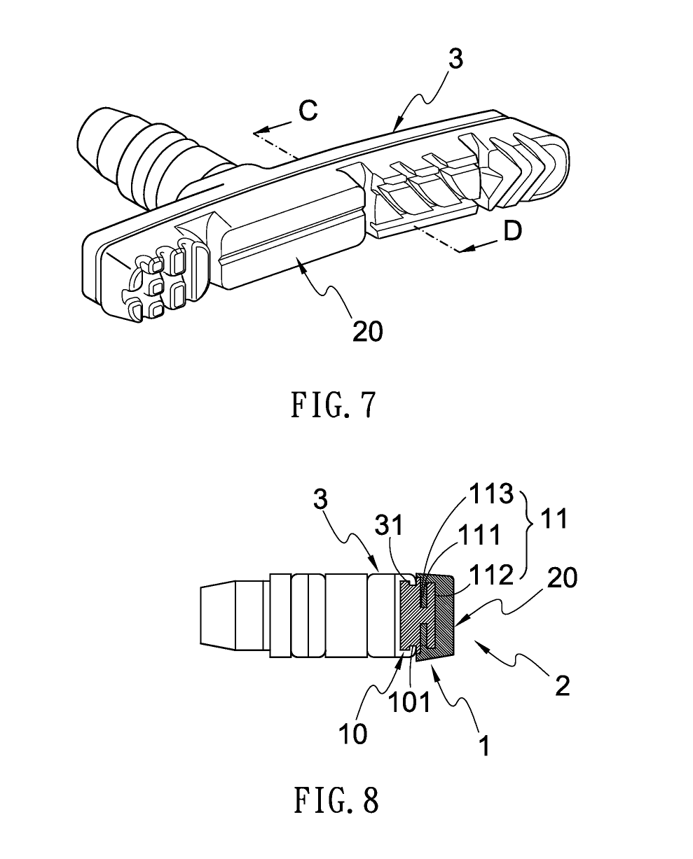

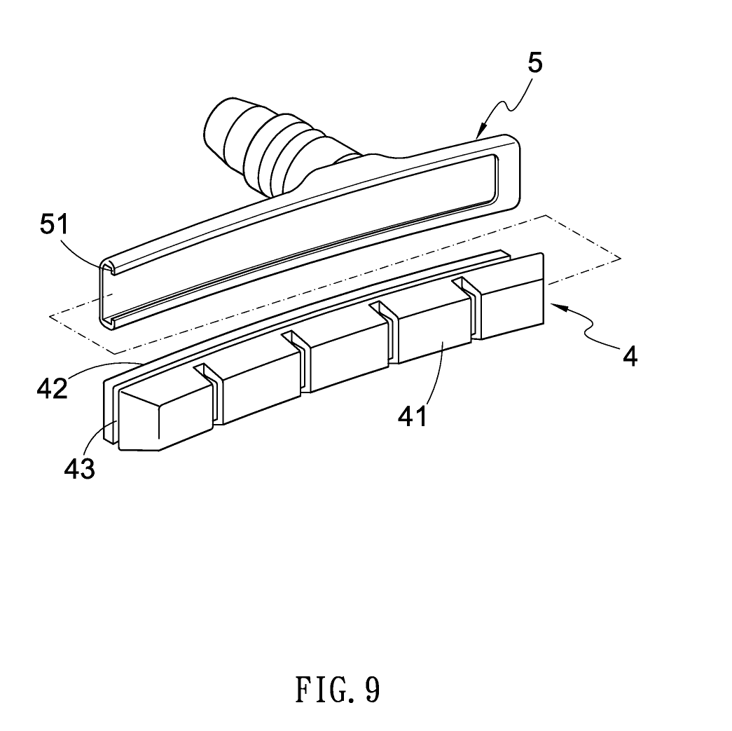

Further referring to FIG. 6 to FIG. 8, which shows the brake block in accordance with the present invention assembled with the holder 3 of bicycle brake shoe. The holder 3 has two flanges 31 extending therefrom and invertedly inclined toward one another. The base 1 is slidably engaged with the two flanges 31 of the holder 3 by the slot 101 circumferentially defined in the outer periphery of the fixing portion 10, such that the fixing portion 10 is embedded in the holder 3 (as shown in FIG. 8) for the base 1 to be securely assembled with the holder 3.

In view of the above descriptions, the brake block in accordance with the present invention has the following advantages: first of all, the base 1 is made by plastic injection molding, such that a tolerance range in size can be reduced to +/−0.05 which is relatively small compares to that of the brake block in accordance with the prior art which is entirely made of rubber by press molding. Therefore, the base 1 can be fittedly assembled with the holder 3 to prevent coming off of the base 1 from the holder 3. Secondly, due to a harder texture of plastic compares to that of rubber, the base 1 is not deformable when being compressed; hence the base 1 rigidly supports the pad body 2 to enhance the frictional effect of the braking portion 20 of the pad body 2 to the wheel rim. Such that the braking portion 20 tightly abuts against the wheel rim to consistently provide a frictional effect in operating state, and the braking portion 20 is not deformed easily with the support from the base 1.

In addition, the color of the base 1 contrasts with that of the pad body 2. By the contrasting colors of the base 1 and the pad body 2, a user can easily identify the wear of the pad body 2, which allows the user to immediately and instantly replace the brake block when the pad body 2 is worn. Furthermore, the connecting plate 112 of the base 1 bursts a friction sound when it is frictionally contacted due to the high coefficient of friction of the connecting plate 112 of the connecting portion 11, such that the user is immediately alerted the wear of the pad body 2 by the friction sound. The connecting plate 112 of the connecting portion 11 also protects the holder 3 from frictionally contacting with the wheel rim when the pad body 2 is worn. Thereby, a usage life of the holder 3 is prolonged.

Although the invention has been explained in relations to its preferred embodiment, it is to be understood that many other possible modifications and variations can be made without departing from the spirit and scope of the invention as hereinafter claimed.

What is claimed is:

1. A brake block for bicycle comprising:
a base made by plastic injection molding, the base having a fixing portion formed on one side thereof and a connecting portion formed on an opposite side thereof; the connecting portion connected with the fixing portion; and
a pad body made of rubber and having one side integrally covering the connecting portion, such that the base and the pad body formed an integral part; the pad body having a braking portion formed on an opposite side thereof for providing frictional effect;
wherein the base and the pad body has a limited tolerance range in size, and is prevented from fracturing or deforming when operating.

2. The brake block for bicycle as claimed in claim 1, wherein the connecting portion includes at least one neck connecting with the fixing portion and a connecting plate mounted on the at least one neck; wherein the connecting plate is thoroughly covered by the pad body.

3. The brake block for bicycle as claimed in claim 2, wherein the connecting portion includes a plurality of necks, a gap defined in two adjacent necks; wherein the pad body is partially fillingly received in the gap.

4. The brake block for bicycle as claimed in claim 1, wherein the fixing portion has a slot circumferentially defined in an outer periphery thereof adapted for slidably engaging with a holder of a bicycle brake shoe.

5. The brake block for bicycle as claimed in claim 1, wherein the base and the pad body having different colors; the color of the base contrasting with that of the pad body for indicating wear of the pad body.

6. The brake block for bicycle as claimed in claim 1, wherein the connecting plate has a high coefficient of friction, such that a friction sound bursts when the connecting plate is frictionally contacted for alerting wear of the pad body.
